(19) United States
(12) Patent Application Publication
(10) Pub. No.: US 2026/0222861 A1
(43) Pub. Date: Jul. 30, 2026

(54) DETERMINING THE ACCURACY OF REFERENCE SIGNAL MEASUREMENT REDUCTION CONFIGURATIONS IN WIRELESS NETWORKS

(71) Applicant: SHARP KABUSHI KAISHA, Sakai City (JP)

(72) Inventors: Sangkyu Baek, Vancouver, WA (US); Tomoki Yoshimura, Camas, WA (US); Zhanping Yin, Vancouver, WA (US); Kenneth Park, Cahtlamet, WA (US); Rudraksh Shrivastava, Erkigheim (DE)

(21) Appl. No.: 19/041,686

(22) Filed: Jan. 30, 2025

(51) Int. Cl. H04W 24/10; H04L 5/00; H04W 72/21; H04W 72/231

(52) U.S. Cl. CPC H04W 24/10; H04L 5/0051; H04L 5/0053; H04W 72/21; H04W 72/231

(57) ABSTRACT

A user equipment (UE) receives, from a network, a first configuration for reference signal (RS) measurement reduction. The UE receives, from the network, a second configuration for determining the accuracy of the first configuration. The second configuration identifies a first time occasion to start determining the accuracy of the first configuration. The UE predicts values of a set of one or more RS occasions that start at the first time occasion. The UE performs measurement of values of the set of RS occasions starting at the first time occasion. The UE determines the accuracy of the first configuration based on the comparison of the predicted values of the set of RS occasions and the measured values of the set of RS occasions.

### TECHNICAL FIELD

The technology generally relates to wireless communications, and more particularly, to controlling reference signal measurement reductions in wireless networks.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the integration of artificial intelligence/machine learning (AI/ML) continues to expand in the 5G NR networks, it has become crucial for user equipment (UE) to accurately discern its serving and neighboring cells' AI/ML functionalities, for example, to ensure smooth handoffs, timely activation of relevant features, and efficient allocation of network resources. However, challenges emerge from dynamic network conditions, as the availability and capabilities of neighboring cells may vary due to factors such as traffic load and interference. In addition, the UE's own capabilities, internal conditions, model availability, and the inherent complexity of 5G NR networks (e.g., including integrated access and backhaul (IAB) systems) further complicate this assessment. To accurately determine the applicable functionalities of neighboring base stations (e.g., next-generation Node Bs (gNBs)) and cells, the UE has to be provided with relevant network-side information, including the appropriate timing for assessing neighboring cell functionalities and the methods for reporting this information back to the network. Reporting neighboring cell AI/ML functionality information may introduce signaling overhead that may affect the network performance.

As the demand for radio access continues to grow, however, there is a need for further improvements in wireless communications in the next-generation radio communication systems, such as improvements in the network mobility management.

### SUMMARY

In a first aspect of the present application, a UE is provided. The UE includes one or more non-transitory computer-readable media storing one or more computer-executable instructions and at least one processor coupled to the one or more non-transitory computer-readable media. The at least one processor is configured to execute the one or more computer-executable instructions to cause the UE to receive, from a network, a first configuration for reference signal (RS) measurement reduction; receive, from the network, a second configuration for determining an accuracy of the first configuration, the second configuration identifying a first time occasion to start determining the accuracy of the first configuration; predict values of a set of one or more RS occasions that start at the first time occasion; perform measurement of values of the set of RS occasions starting at the first time occasion; and determine the accuracy of the first configuration based on a comparison of the predicted values of the set of RS occasions and the measured values of the set of RS occasions.

In an implementation of the first aspect, the second configuration specifies a periodicity for the first time occasion.

In another implementation of the first aspect, the at least one processor is further configured to execute the one or more computer-executable instructions to cause the UE to transmit, to the network, the accuracy of the first configuration via radio resource control (RRC) signaling.

In another implementation of the first aspect, the second configuration further specifies the number of RS occasions in the set of RS occasions.

In another implementation of the first aspect, the number of RS occasions in the set of RS occasions is determined by the UE.

In another implementation of the first aspect, the second configuration identifies the first time occasion as a one-time accuracy determination occasion.

In another implementation of the first aspect, the at least one processor is further configured to execute the one or more computer-executable instructions to cause the UE to transmit, to the network, the accuracy of the first configuration either an RRC signaling, an Uplink Control Information (UCI), or a Medium Access Control-Control Element (MAC CE).

In another implementation of the first aspect, performing the measurement of values of the set of RS occasions includes performing measurement of values of a first group of RSs prior to the first time occasion, calculating an average of the measured value of each RS occasion in the set of RS occasions and the measured values of the first group of prior RS occasions, and using the averaged values as the measured values of the set of RS occasions to determine the accuracy.

In another implementation of the first aspect, performing the measurement of values of the set of RS occasions includes calculating an average of the measured value of each RS occasion in the set of RS occasions and a measured value of a prior RS occasion, and using the averaged values as the measured values of the set of RS occasions to determine the accuracy.

In another implementation of the first aspect, the first configuration is for measurement reduction of RSs received from a serving network cell that uses a first frequency band, the at least one processor is further configured to execute the one or more computer-executable instructions to cause the UE to receive, from the network, a third configuration for measurement reduction of RSs received from a second network cell that uses a second frequency band different than the first frequency band; receive, from the network, a fourth configuration for determining an accuracy of the third configuration; and activate a measurement gap during which the UE performs accuracy determination based on the fourth configuration, where the UE does not receive scheduling from the serving network cell during the measurement gap.

In another implementation of the first aspect, the at least one processor is further configured to execute the one or more computer-executable instructions to cause the UE to receive the measurement gap, from the network, via RRC signaling.

In another implementation of the first aspect, the at least one processor is further configured to execute the one or more computer-executable instructions to cause the UE to: receive, from the network, an accuracy threshold; and stop using the first configuration when the accuracy of the first configuration is below the threshold.

In another implementation of the first aspect, the RS is either a synchronization signal block (SSB), a channel state information reference signal (CSI-RS), a sounding reference signal (SRS), or a phase tracking reference signal (PT-RS).

In another implementation of the first aspect, predicting the values of the set of RS occasions includes using an AI/ML prediction model.

In a second aspect of the present application, a method is provided. The method includes receiving by a UE, from a network, a first configuration for RS measurement reduction; receiving, from the network, a second configuration for determining an accuracy of the first configuration, the second configuration identifying a first time occasion to start determining the accuracy of the first configuration; predicting values of a set of one or more RS occasions that start at the first time occasion; performing measurement of values of the set of RS occasions starting at the first time occasion; and determining the accuracy of the first configuration based on a comparison of the predicted values of the set of RS occasions and the measured values of the set of RS occasions.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIG. 2 is a diagram illustrating an example of skipping measurement occasions in the AI/ML-assisted measurement reduction, according to prior art.

FIG. 3 is a diagram illustrating an example of different accuracies of the AI/ML-assisted measurement reduction for different coverage levels, according to an example implementation of the present disclosure.

FIG. 4 is a diagram illustrating an example of two different measurement reduction configurations configured for a UE to use under different conditions, according to an example implementation of the present disclosure.

FIG. 5 is a diagram illustrating an example of the measurement reduction configurations of one network cell being dependent on conditions of another network cell, according to an example implementation of the present disclosure.

FIG. 6 is a sequence diagram illustrating an example of signaling of the UE Assistance Information for the measurement reduction configuration, according to an example implementation of the present disclosure.

FIG. 7 is a flowchart illustrating an example method/process performed by a UE for conditional RS measurement reduction, according to an example implementation of the present disclosure.

FIG. 8 is a diagram illustrating an example of the periodic accuracy calculation of the AI/ML-assisted measurement reduction, according to an example implementation of the present disclosure.

FIG. 9 is a diagram illustrating an example of a one-shot accuracy calculation of the AI/ML-assisted measurement reduction, according to an example implementation of the present disclosure.

FIG. 10 is a flowchart illustrating an example method/process performed by a UE for determining the accuracy of RS measurement reduction configurations, according to an example implementation of the present disclosure.

FIG. 11 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam may be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference Signal (PT-RS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control-Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected, as the representative AI/ML sub-use cases. The first use case (BM-Case1) may include spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the network side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal received power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may include temporal downlink beam prediction for Set A of beams based on the historic measurement results of Set B of beams. For the BM-Case2, the following alternatives may be considered. The AI/ML model training and inference may be done either at the network side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like KPIs, the AI/ML model may provide output in the form of F(f1,f2 . . . fn) predictions for T(t1,t2, . . . tn) future time instances. The prediction may reflect predicted beams and their corresponding configurations.

RAN work group 2 (RAN WG2 or RAN2), during phase 1 discussions, has defined different functionality types for AI/ML functionalities. A functionality may refer to an AI/ML-enabled feature, or feature group, facilitated by a configuration. A functionality, in the context of AI/ML-enabled 5G NR and beyond communication systems, may refer to a specific feature, or a collection of related features, that is enabled by artificial intelligence or machine learning capabilities. These functionalities are supported and managed through configurations, which are sets of parameters or instructions that dictate how the AI/ML enabled a 5G NR (or beyond) system should operate. Essentially, a configuration ensures that the functionality works correctly by providing the necessary settings and data for the AI/ML processes including the life cycle Management (LCM) of the AI/ML model/functionality to work effectively.

Technical document TR 38.843 (Study on Artificial Intelligence (AI)/Machine Learning (ML) for NR air interface) provided the following definitions for the AI/ML models:
AI/ML-enabled Feature: Refers to a Feature where AI/ML may be used.
AI/ML Model: A data driven algorithm that applies AI/ML techniques to generate a set of outputs based on a set of inputs.
AI/ML model Inference: A process of using a trained AI/ML model to produce a set of outputs based on a set of inputs.
Model activation: Enable an AI/ML model for a specific AI/ML-enabled feature.
Model deactivation: Disable an AI/ML model for a specific AI/ML-enabled feature.
Two-sided (AI/ML) model: A paired AI/ML Model(s) over which joint inference is performed, where joint inference includes AI/ML Inference whose inference is performed jointly across the UE and the network, i.e., the first part of inference is first performed by UE and then the remaining part is performed by gNB, or vice versa.
UE-side (AI/ML) model: An AI/ML model whose inference is performed entirely at the UE.

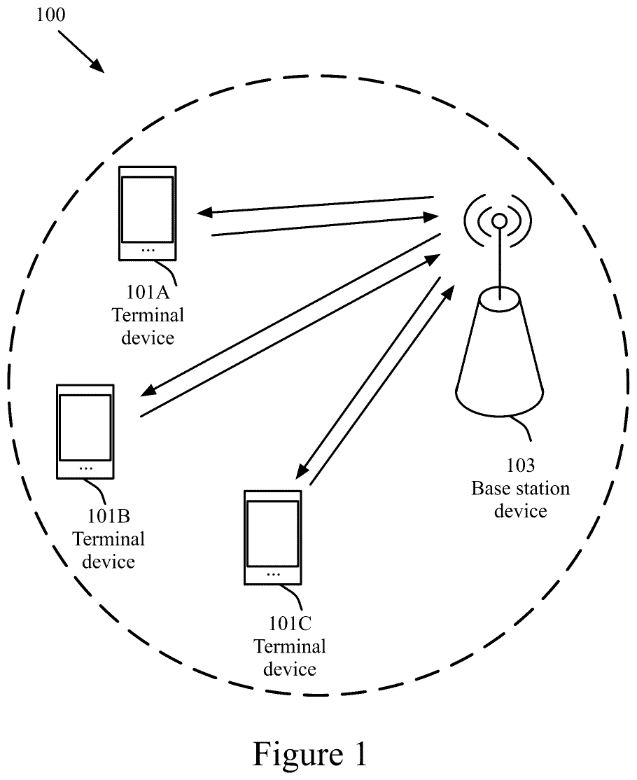

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured with multiple transmission/reception devices, each of the multiple transmission/reception devices may be arranged at a different position. A transmission/reception device may include a transmission device and/or a reception device.

BS 103 may serve radio communication and provide one or more cells. A cell is defined in this disclosure, as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to the UE 101A-101C for a given AI/ML functionality. The BS 103, or the other network node, may provide a mechanism to change the configuration sets based on changes in the UE's environment and/or additional conditions.

In a wireless communication system, the RRC configuration process may be used for setting up, maintaining, and modifying the radio connection between the UE and the BS (e.g., a gNB) in the 5G/5G-Advanced (5G-A) networks. The BS 103 or the network entity, may send an RRC message to a UE 101A-101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network, or network node, refers to any network entity, such as, BS (e.g., gNB), LMF server, etc., and the BS 103 may be used as an example of such network node.

The term “configuration,” herein, may refer to the arrangement and specification of components, settings, or parameters within a system or device, as defined by the applicable agreements, standards, or specifications. The term configuration may encompass the established setup and customization of elements necessary to ensure compliance with contractual obligations, operational requirements, and performance criteria.

### Conditional Reference Signal Measurement Reduction

The AI/ML may be used to reduce actual measurement of reference signals (RSs). The RSs may, for example, be SSBs, CSI-RSs, SRSs, or PT-RSs. The AI/ML inference may derive AL/ML-assisted measurement data, instead of actual measurement data.

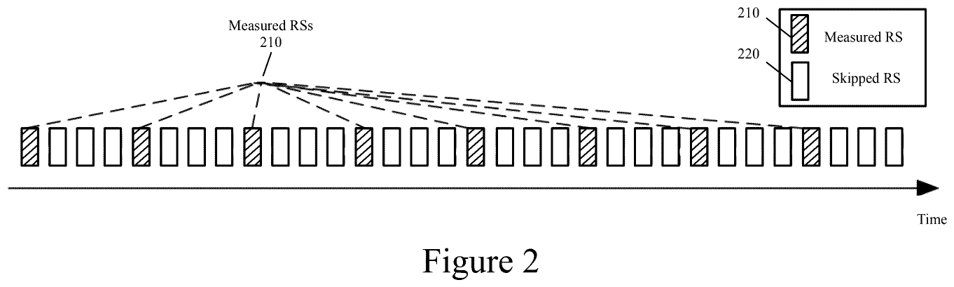

FIG. 2 is a diagram illustrating an example of skipping measurement occasions in the AI/ML-assisted measurement reduction, according to prior art. As a performance metric of the measurement reduction, Measurement Reduction Rate in Temporal domain (MRRT) may be used. The MRRT may be defined as the number of skipped measurement time instances divided by the total number of measurement time instances. In FIG. 2, instead of measuring all RSs, the UE may measure every four RSs 210. The UE may skip all other RSs 220, and the AI/ML inference may derive a value corresponding to the measurement. In FIG. 2, the MRRT is 75%=¾.

The MRRT may be derived by the measurement configuration. In wireless communications systems, the BS or other network entities may decide the measurement configuration by considering the accuracy of the AI/ML-assisted measurement reductions. For example, in case that the AI/ML inference has high accuracy, a measurement configuration with higher measurement reduction rate (e.g., a higher MRRT) may be configured. The accuracy of the AI/ML-assisted measurement reduction may depend on the UE's location or coverage conditions. Also, depending on the necessity of mobility decision (e.g., handover), less accurate measurement may be acceptable. Furthermore, line-of-sight (LOS) and non-line-of-sight (NLOS) may have different accuracies of the AI/ML-assisted measurement reduction.

Frequent RS measurements, while crucial for network performance, may consume significant resources. The problem is to develop an AI/ML-assisted measurement reduction procedure that may decrease the frequency of actual RS measurements while maintaining acceptable accuracy. This system should adapt to various network conditions, utilize metrics like the MRRT, and dynamically adjust configurations based on factors such as the AI/ML inference accuracy, the UE location, and the coverage conditions.

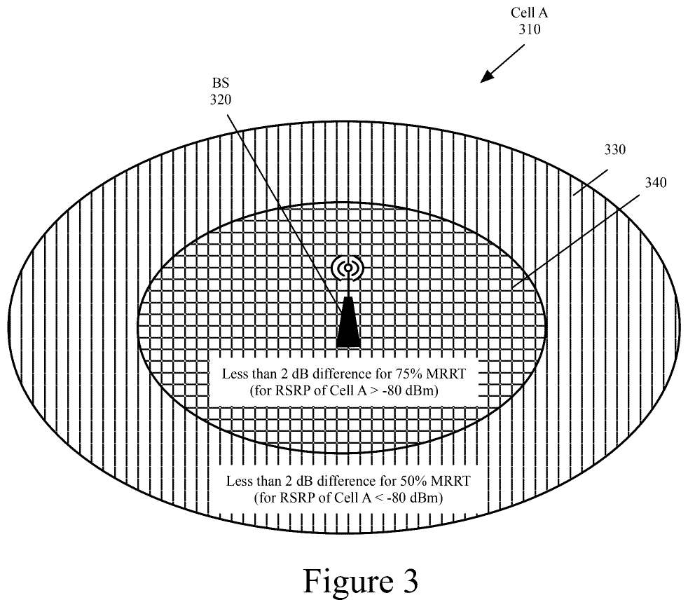

FIG. 3 is a diagram illustrating an example of different accuracies of the AI/ML-assisted measurement reduction for different coverage levels, according to an example implementation of the present disclosure. In FIG. 3, cell A 310 of the BS 320 may include two regions 330 and 340. When the UE is in the region 340 that has an RSRP above −80 decibels relative to 1 milliwatt (dBm), the AI/ML inference may guarantee an accuracy of less than 2 dB for 75% MRRT. When the UE is in the region 330 that has an RSRP below −80 dBm, the AI/ML inference may guarantee an accuracy less than 2 dB for 50% MRRT. The example of FIG. 3 provides an example of location-dependent accuracy of RS measurement reduction.

In some embodiments, different measurement reduction configurations may be used for different conditions. The BS or another network entity may configure multiple AI/ML-assisted measurement reduction configurations. Each measurement reduction configuration may be associated with a condition. When a condition is met, the UE may apply the corresponding measurement reduction configuration.

The condition may be signal quality of a network cell. For example, the condition may be the RSRP being higher than a threshold, the reference signal received quality (RSRQ) being higher than a threshold, the SINR being higher than a threshold. The condition may be the RSRP difference between two network cells being higher than a threshold, the RSRP difference between two TRPs in the network being higher than a threshold, the achievable accuracy of the RS measurement reduction being higher than a threshold, the LOS/NLOS status of the UE being true, the speed of the UE being within a range of speeds, or the location of the UE being within a particular region. The condition may also be a combination of several of these conditions.

The conditional RS measurement reduction may be used for a mobility decision (e.g., handover) or measurement reporting in RRC_CONNECTED. Also, it may be used for cell reselection in the RRC_INACTIVE or the RRC_IDLE. In some embodiments, the UE may report the UE's preference on the AI/ML-assisted measurement reduction configuration from the UE to the BS or another network entity. The UE may use UE Assistance Information (UAI) to report the UE's preference.

For measurement reporting or the UE-based handover in the RRC_CONNECTED state, the measurement reductions configurations may be configured from the BS to the UE via control signaling. The control signaling may be an RRC message. The control signaling may include measurement reduction configuration and the corresponding conditions. The measurement reduction configuration may be a corresponding MRRT. The measurement reduction configuration may be per cell, which implies that different cells may have different measurement reduction configurations. It is also possible that more than two measurement reduction configurations be used for different conditions.

For cell selection or cell re-selection procedures in the RRC_INACTIVE or the RRC_IDLE state, the measurement reduction configuration may be included in a broadcast signaling. The broadcast signaling may be system information signaling transmitted by the BS. Based on the received measurement reduction configuration, the UE may perform the measurement and cell reselection. The broadcast signaling may include at least one of the followings: whether the measurement reduction is allowed, the allowed measurement reduction configurations, the allowed MRRT, and the periodicity of required accuracy calculation of the measurement reduction configuration. When the UE enters RRC_CONNECTED, the applied measurement reduction configuration in the RRC_IDLE or the RRC_INACTIVE for cell selection or cell re-selection may be reported to the BS.

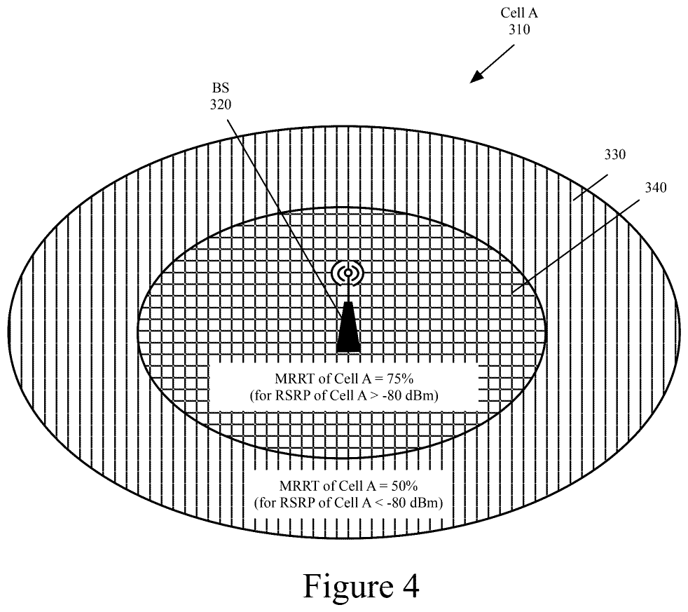

FIG. 4 is a diagram illustrating an example of two different measurement reduction configurations configured for a UE to use under different conditions, according to an example implementation of the present disclosure. In the example of FIG. 4, the RSRP is used as a condition to determine the configuration that the UE may use.

For the RSRP of cell A 310 greater than −80 dBm (e.g., when the UE is in the region 340), the UE may use a measurement reduction configuration with the MRRT of 75% for performing the RS measurements. For the RSRP of cell A 310 smaller than −80 dBm (e.g., when the UE is in the region 330), the UE may use a measurement reduction configuration with the MRRT of 50% for performing the RS measurements.

In the example of FIG. 4, the UE uses a particular measurement reduction configuration based on its RSRP to the same cell. In an alternative embodiment, other signal quality metrics such as the RSRQ or the SINR may be used.

In some embodiments, each measurement reduction configuration for a cell may be associated with a difference between two cells or two TRPs (e.g., the difference between RSRPs, RSRQs, SINRs, etc.). The two cells, or the two TRPs, may be configured by the BS to the UE. The two cells, or the two TRPs, may include a serving cell of the UE.

In some embodiments, each measurement reduction configuration for a cell may be associated with an achievable accuracy of measurement reduction configuration. For example, multiple measurement reduction configurations may be configured to a UE, and the UE may select a measurement reduction configuration which meets the accuracy requirements. Alternatively, the UE may select a measurement reduction configuration which meets the accuracy requirement and have the highest measurement reduction (e.g., the highest MRRT). The accuracy requirement may be the average difference between the AI/ML-assisted measurement and the actual measurement. The achievable accuracy requirement may be configured by the BS to the UE via control signaling.

In some embodiments, each measurement reduction configuration for a cell may be associated with the LOS/NLOS status. For example, the UE may have two configurations for the LOS and NLOS, respectively. In some embodiments, each measurement reduction configuration for a cell may be associated with the UE speed. For example, a UE may be configured with three measurement reduction configurations for a cell, which are associated with high speed, medium speed, low speed, respectively.

In some scenarios, the accuracy of measurement reduction may depend on the UE location. For example, the accuracy of measurement reduction may be low in urban areas. In some embodiments, a UE may be configured with a measurement reduction configuration to be used for a particular UE location.

In another alternative embodiment, each measurement reduction configuration for a cell may be associated with a combination of more than one condition. For example, a measurement reduction configuration may be associated with a combination of two or more of signal quality (RSRP, RSRQ, SINR), the RSRP difference between two cells or two TRPs, the achievable accuracy of measurement reduction, the LOS/NLOS status, the UE speed, and the UE location. For example, a UE may be configured with a measurement reduction configuration to be used when its RSRP is below a threshold and UE speed at that time is low.

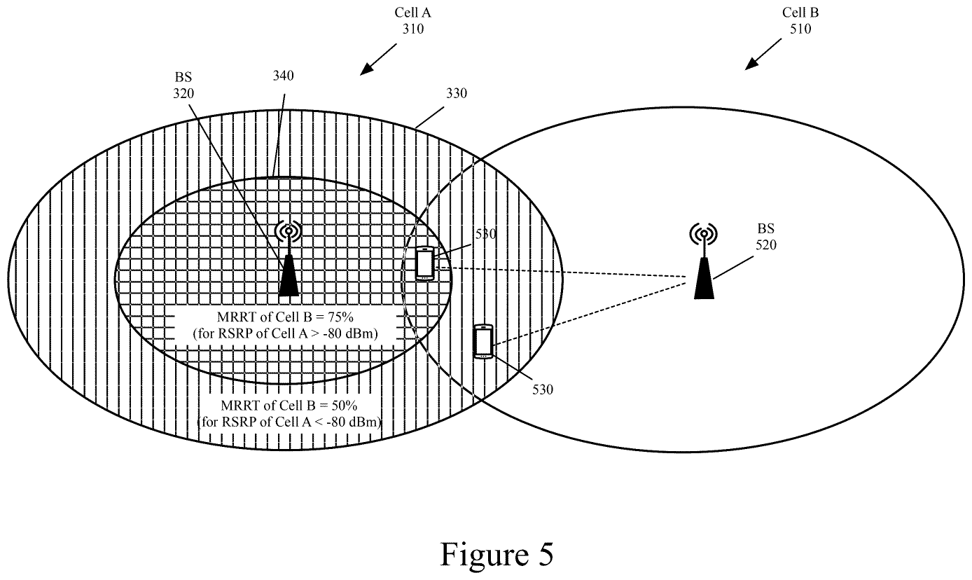

FIG. 5 is a diagram illustrating an example of the measurement reduction configurations of one network cell being dependent on conditions of another network cell, according to an example implementation of the present disclosure.

In the example of FIG. 5, the UE 530 may have two measurement reduction configurations for Cell B 510. The condition to select a configuration may be based on the signal quality of Cell A 310. For example, the RSRP of Cell A 310 may be used as the signal quality to determine the configuration that the UE 530 may use for the RS measurement reduction of Cell B 510.

For the RSRP of Cell A 310 greater than −80 dBm (e.g., when the UE 530 is in the region 340), the UE may use a measurement reduction configuration with the MRRT of 75% for Cell B measurements. For the RSRP of cell A 310 smaller than −80 dBm (e.g., when the UE 530 is in the region 330), the UE may use a measurement reduction configuration with the MRRT of 50% for Cell B measurements.

The measurement reduction configurations that depend on signal quality may be used for measurement reporting or UE-based handover in the RRC_CONNECTED state. The measurement reductions configurations may be configured from the BS to the UE via control signaling. The control signaling may, for example, be an RRC message. The control signaling may include measurement reduction configuration and the corresponding conditions. The measurement reduction configuration may be a corresponding MRRT. The measurement reduction configuration may be per cell. This may imply that different cells have different measurement reduction configurations. It is also possible that more than two measurement reduction configurations be used for different conditions.

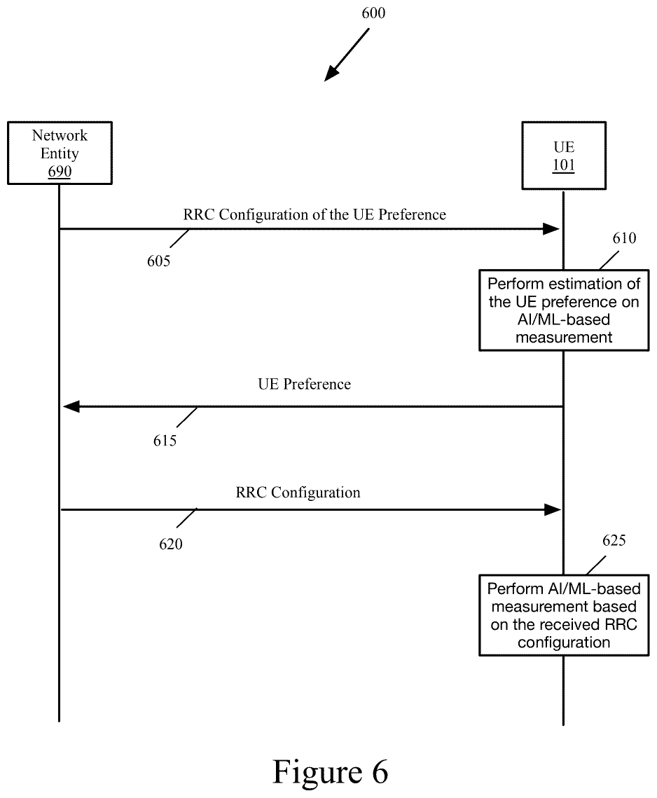

FIG. 6 is a sequence diagram 600 illustrating an example of signaling of the UAI for the measurement reduction configuration, according to an example implementation of the present disclosure. The wireless communication system may include, for example, a 3GPP network, such as, the 5G/5G-A or the 6^{th} generation (6G) NR system. The UE 101 may be any of the UEs 101A-101C and the network node 690 may be the BS 103, as shown in FIG. 1, or any other network entity, for example, network/UE relays, etc.

In case that the network entity 690 decides that all configuration of the AI/ML-assisted measurement reduction is to be used at the UE side, the UE 101 may need to provide the UAI information (e.g., the UE's preference and the UE's status on measurement reduction configuration). It may be possible that the UE may have more information than the network. Based on the UE's reporting, the network entity 690 may determine the configuration of the AI/ML-assisted measurement reduction.

The network entity 690 may send (at step 605) a message to the UE 101, which may configure that the UE is required to report the UE preference on measurement reduction configuration. The preferred measurement reduction configuration may be replaced by the UE's referred MRRT. The message in step 605 may, for example, be an RRC configuration message which configures the UE preference on measurement reduction configuration. The message may configure one or more specific conditions to the UE to report its preference per specific condition.

The condition may be associated with one or more of the followings: the signal quality of the cell (e.g., the RSRP, the RSRQ, the SINR), the RSRP difference between two cells or two TRPs, the achievable accuracy of measurement reduction, the LOS/NLOS status, the UE speed, the UE location, the network load, the Quality of Service (QoS), the Quality of Experience (QoE), the UE energy saving status, or a combination of more than one of those.

In some embodiment, the condition may be associated with the predicted value of one or more of the followings: the signal quality of the cell (the RSRP, the RSRQ, the SINR (signal), the RSRP difference between two cells or two TRPs, the achievable accuracy of measurement reduction, the LOS/NLOS status, the UE speed, the UE location, or a combination of more than one of those. In another embodiment, this specific condition may be a composite metric which was derived by the AI/ML inference using the UE-side information such as the signal quality, the speed, the LOS/NLOS status, the network load, the QoS, the QoE, the UE energy saving status, etc. In some embodiments, the network entity 690 may configure the required accuracy level and let the UE 101 report its preference per accuracy level.

According to the configuration from the network entity 690, the UE 101 may perform (at block 610) an estimation of the UE preference on the AI/ML-based measurement reduction. The estimation, for example, may include the accuracy calculation of possible measurement reduction configurations.

After the UE 101 performs the estimation of UE preference on the AI/ML-based measurement reduction, the UE 101 may send (at step 615) a message which includes the UE's preference on the AI/ML-based measurement reduction. In this message, the UE 101 may report the preferred MRRT for a cell or a specific RS of the cell. In some embodiments, the preference may be per frequency band. The preferred MRRT may be associated with accuracy. It may be the maximum MRRT which meets the required accuracy level. The UE's preferred measurement reduction configuration may include the measurement periodicity. Additionally, the UE 101 may report the preference on periodicity and duration for the calculation of accuracy of measurement reduction configuration.

With the UE preference, the network entity 690 may decide the measurement reduction configuration for the UE 101. The network entity 690 may send (at step 620) an RRC configuration including the measurement reduction conditions. The UE 101 may apply the configuration. The UE 101 may perform (at block 625) the AI/ML-based measurement reduction (e.g., the AI/ML-based measurement).

In some embodiments, the measurement reduction configuration may have a validity time indicating how long the received measurement reception configuration is valid. The RRC configuration in step 620 may include the validity time. The validity time may be a timer or an absolute time. If the validity time is a timer, the timer may start at the reception of the RRC configuration by the UE. If the timer expires, the UE may delete the received measurement reduction configuration or the UE may not apply the measurement reduction configuration any more. If the validity time is an absolute time (e.g. Jan. 20, 2024, 1:30:23 PM), at the indicated time, the UE may delete the corresponding measurement reduction configuration or the UE may not apply the measurement reduction configuration any more.

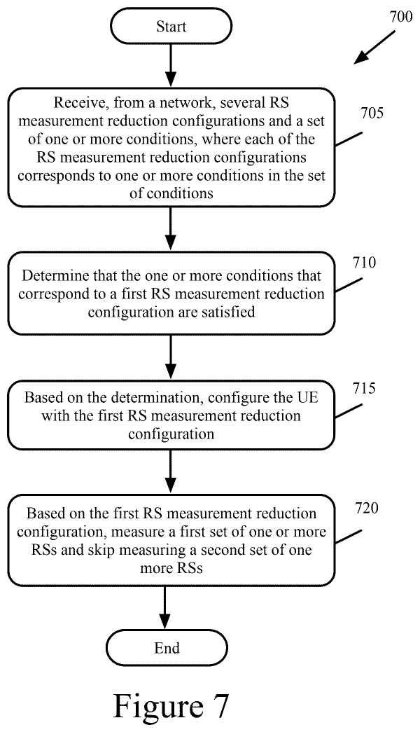

FIG. 7 is a flowchart illustrating an example method/process 700 performed by a UE for conditional RS measurement reduction, according to an example implementation of the present disclosure. The process 700 may be performed by at least one processor of a UE 101A-101C, shown in FIG. 1.

The process 700 may receive (at block 705), from a network, several RS measurement reduction configurations and a set of one or more conditions. Each of the RS measurement reduction configurations may correspond to one or more conditions in the set of conditions. Each of the RS measurement reduction configurations, in some embodiments, may include a validity time indicating how long the RS measurement reduction configuration is valid. The validity time may be based on an absolute time or a timer. The timer, in some embodiments, may start at the reception of the RS measurement reduction configuration by the UE. The timer, in other embodiments, may start at the occurrence of the one or more conditions that correspond to the RS measurement reduction configuration. In some embodiments, the RS measurement reduction configurations may be associated with a several network cells, and at least two network cells may use different RS measurement reduction configurations.

The process 700 may determine (at block 710) that the one or more conditions that correspond to a first RS measurement reduction configuration are satisfied. For example, the process 700 may determine that the RSRP, the RSRQ, the SINR, the RSRP difference between two network cells, the RSRP difference between two TRPs in the network, or the achievable accuracy of the RS measurement reduction are higher than a threshold. As another example, the process 700 may determine that the LOS/NLOS status of the UE is true (or false), the speed of the UE is within a particular range of speeds, or the location of the UE is within a particular region.

The process 700, based on the determination, may configure (at block 715) the UE with the first RS measurement reduction configuration. The first RS measurement reduction configuration, in some embodiments, may correspond to an MRRT that defines the number of skipped RS measurement time instances divided by the total number of measurement time instances.

The process 700, based on the first RS measurement reduction configuration, may measure (at block 720) a first set of one or more RSs and may skip measuring a second set of one more RSs. For example, the process 700 may measure the RSs 210 and may skip the RSs 220, as shown in FIG. 2. The process 700 may then end.

The process 700, in some embodiments, may receive, from the network, a configuration that requires the UE to report the UE's preference associated with the RS measurement reduction configurations. The process 700, in these embodiments, may perform an estimation of the UE's preference for RS measurement reduction configurations, and may transmit the UE's preference, to the network. The process 700 may receive the configuration that requires the UE to report the UE's preference from the network via RRC signaling.

The configuration requiring the UE to report the UE's preference may include a set of one or more conditions for reporting the UE's preference to the network. The set of one or more conditions for reporting the UE's preference may be associated with one or more of the RSRP, the RSRQ, the SINR, the RSRP difference between two network cells, the RSRP difference between two TRPs of the network, the achievable accuracy of the RS measurement reduction, the LOS/NLOS status of the UE, the speed of the UE, the location of the UE, the network load, the QoS, the QoE, or the UE energy saving status. The process 700, in some embodiments, may determine the set of one or more conditions for reporting the UE's preference based on one or more of (i) several actual measurements performed by the UE, or (ii) several values predicted by an AI/ML model. In some embodiments, the set of one or more conditions for reporting the UE's preference may be based on an accuracy level of the RS measurements required by the UE. The UE's preference may include one or more of a frequency band among several frequency bands, a preferred MRRT for a network cell, a preferred MRRT for an RS of a network cell, a measurement periodicity for the calculation of the accuracy of measurement reduction configuration, or the duration for the calculation of accuracy of measurement reduction configuration.

The conditions, in some embodiments may include the RSRP being higher than a threshold, the RSRQ being higher than a threshold, the SINR being higher than a threshold, the RSRP difference between two network cells being higher than a threshold, the RSRP difference between two TRPs in the network being higher than a threshold, the achievable accuracy of the RS measurement reduction being higher than a threshold, the LOS/NLOS status of the UE being true, the speed of the UE being within a particular range of speeds, or the location of the UE being within a particular region.

In a case that the UE is in an RRC_CONNECTED) state, the process 700 may perform a prediction for values of the second set of RSs, and may perform a handover from a first network cell to a second network cell based on the measurement of the first set of RS measurements and the predicted values of the second set of RSs.

In a case that the UE is in either an RRC_INACTIVE state or an RRC_IDLE state, the process 700 may receive the RS measurement reduction configurations via broadcast signaling. The process 700 may perform a prediction for values of the second set of RSs, and may perform either a network cell selection procedure or a network cell re-selection procedure based on the measurement of the first set of RS and the predicted values of the second set of RSs.

The process 700 may determine that the one or more conditions corresponding to a second RS measurement reduction configuration are satisfied. Based on the determination, the process 700 may configure the UE with the second RS measurement reduction configuration. The process 700, based on the second RS measurement reduction configuration, may measure a third set of one or more RSs and skip measuring a fourth set of one more RSs.

### Accuracy Calculation of AI/ML-Assisted Measurement Reduction

The accuracy of the AI/ML-assisted mobility reduction may be calculated by comparing the AI/ML inference results with the actual measurement results. The derivation of the actual measurement results requires full measurement of RSs, which is energy consuming. The UE may, therefore, want to minimize it. However, frequent accuracy calculation increases the reliability of the AI/ML-assisted mobility reduction. The network may want to control when the UE measures all RSs to calculate the accuracy of the AI/ML-assisted measurement reduction.

Since the measurement is performed by the UE, the UE may have better information on the required measurement configuration for the accuracy requirements than the network. To configure the best measurement configuration to the UE, the network may want the UE to report assistance information.

The network, in some embodiments, may configure when and how the UE may calculate the accuracy of the AI/ML-assisted measurement reduction configuration. The calculation may be periodic or one-shot. The configuration, in some embodiments, may provide the duration of accuracy calculation. In other embodiments, the UE may determine the duration of accuracy calculation. Yet, in other embodiments, the duration of accuracy may be pre-determined. The configuration may provide one or more of the followings: A measurement gap activation for accuracy calculation, multiple accuracy calculations for multiple measurement reduction configurations, event-based accuracy reporting, applicability decision of the functionality depending on the calculated accuracy. The UE, in some embodiments, may perform layer-1 (L1)/layer-3 (L3) filtering for accuracy calculation.

### Periodic Accuracy Calculation

Some embodiments may provide a method for the UE to perform the accuracy calculation of the AI/ML-assisted measurement reduction. The accuracy calculation requires full measurement of RSs such as SSB, CSI-RSs, SRSs, or PT-RSs

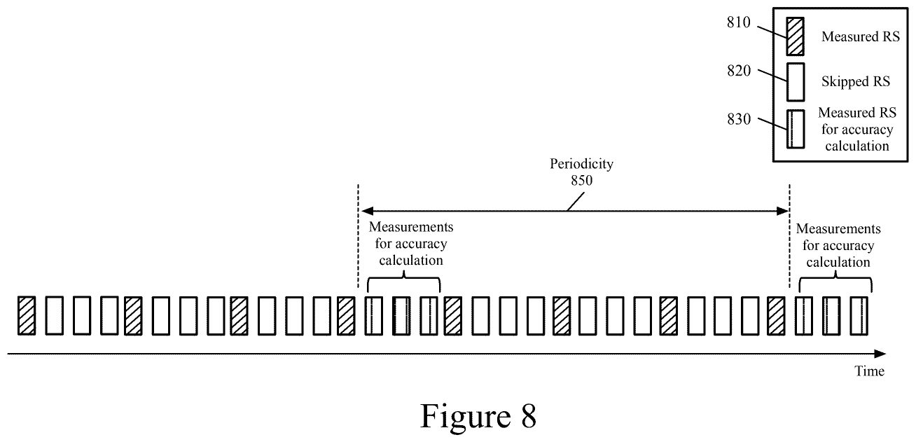

FIG. 8 is a diagram illustrating an example of the periodic accuracy calculation of the AI/ML-assisted measurement reduction, according to an example implementation of the present disclosure. The AI/ML-assisted measurement reduction allows the UE to skip some RSs 820. The UE may perform actual measurements for selected RSs 810. The accuracy calculation may be performed periodically (as shown by the periodicity 850). The measurement reduction configuration provided by the network (e.g., the BS or another network entity) may determine the RSs which the UE has to measure or skip. In FIG. 8, the UE performs actual measurement every four RS, the corresponding MRRT is, therefore, 75%=¾.

To calculate the accuracy of the measurement reduction configuration, the network may configure at least the periodicity that the UE may calculate the accuracy. The network, in some embodiments, may LSO configure the duration for the accuracy measurement, which means how long (e.g., how many consecutive RSs 830) the UE may perform the actual measurement for the accuracy calculation. In other embodiments, the UE may determine the duration of the accuracy calculation.

In the example of FIG. 8, the periodicity of the accuracy calculation is 16 RSs, and the UE performs the actual measurements for 3 RSs for accuracy calculation. In some embodiments, the UE may use not only the actual measurement results configured for accuracy calculation (e.g., the measurements of RSs 830) but also may use the actual measurement results (e.g., the measurements of RSs 810) being used for the AI/ML-assisted measurement reduction. The UE may apply the received configuration of accuracy calculation and may perform the accuracy calculation. An RRC message may be used for configuration of accuracy calculation.

The network configure the accuracy calculation for multiple measurement reduction configurations even if some of the measurement reduction configurations are not being used by the UE. In other words, the network may configure the accuracy calculation for multiple MRRT values.

In some embodiments, the accuracy calculation may be performed for different frequency bands. For example, the UE may perform RS measurement reduction for a serving cell and a neighboring cell that operate in different frequency bands. In these embodiments, the UE may perform the accuracy calculation in different frequency bands.

If the accuracy calculation is performed for inter-frequency measurement reduction, a measurement gap may be configured. During the measurement gap, the UE does not expect the scheduling from the serving cell. The measurement gap may be periodically configured and aligned with periodicity of the accuracy measurement. When the UE performs the accuracy calculation, the UE may need to have a dense measurement gap. As the information is known to both the network and the UE, the UE may activate the measurement gap when the UE performs the accuracy calculation. The network may configure to the UE whether to apply the measurement gap during the accuracy calculation. An RRC message may be used for configuration of the measurement gap that is activated during the accuracy calculation.

When a calculated accuracy of an AI/ML-assisted measurement reduction configuration is lower than a threshold, the UE may consider the functionality corresponding to the configuration as not applicable. The threshold may be configured by the network, for example, via an RRC message. When a calculated accuracy of an AI/ML-assisted measurement reduction configuration is higher than a threshold, the UE may consider the functionality corresponding to the configuration as applicable. The threshold may be configured by the network, for example, via an RRC message.

The accuracy calculation is performed by using measurement sample after L1 and/or L3 filtering. The L1 filtering may occur at the Physical Layer of the 5G protocol stack. It processes raw measurements collected by the UE, such as signal quality indicators (e.g., RSRP, RSRQ, SINR). L1 filtering may be used in handover and cell reselection decisions, and may help smoothing out noise and short-term fluctuations in the radio measurements to provide a stable output for higher-layer processes.

The L3 filtering may occur at the RRC Layer. It may take the already-processed measurements from the L1 filtering and may apply additional filtering for the decision-making processes. The L3 filtering may be used to ensure stability in mobility-related decisions like handover or reselection, by further smoothing the input from L1 filtering.

In order to obtain the L1 filtered measurement, the UE may start to perform the actual measurement in advance, and the L1 filtered measurement may obtained by averaging multiple samples of the actual measurements. The L3 filtering may be performed by averaging a measurement with its immediately preceding measurement.

The UE may report the calculated accuracy for each measurement reduction configuration to the network. For example, an RRC message may be used for the report of the calculated accuracy. The calculated accuracy, in some embodiments, may be reported periodically. In another embodiments, the calculated accuracy may be reported when an event occurs. For example, an event may be that the calculated accuracy is lower than a threshold or higher than a threshold. The threshold may be configured by the network, for example, via an RRC message. If periodic reporting is configured, the periodicity that the UE reports the accuracy may be configured by the network, for example, via an RRC message.

### One-Shot Accuracy Calculation

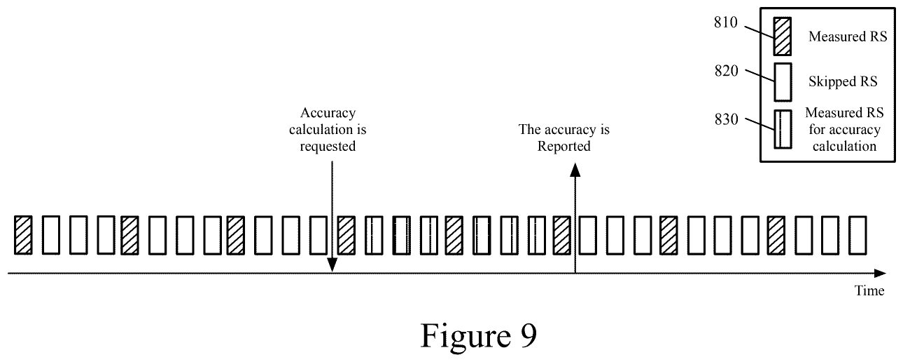

FIG. 9 is a diagram illustrating an example of a one-shot accuracy calculation of the AI/ML-assisted measurement reduction, according to an example implementation of the present disclosure. The AI/ML-assisted measurement reduction may allow the UE skips some RSs 820. The UE may perform actual measurements for RSs 810 for RS measurement. The UE may perform actual measurements for selected RSs 830 for accuracy measurement. The measurements for the RSs 830 may be performed in a one-shot manner when the UE is required to do by the network. The measurement reduction configuration provided by the network may determine the RSs which the UE shall measure or skip. In FIG. 9, the UE performs actual measurement every four RS 810, the corresponding MRRT is, therefore, 75%=¾.

To calculate the accuracy of the measurement reduction configuration, the network may ask the UE to calculate the accuracy. Also, the network may optionally configure the duration of accuracy calculation, which means how long (e.g., how many consecutive RSs) the UE performs the actual measurement for the calculation. The network may send a DCI, a MAC CE, or an RRC message to ask the UE to perform the one-shot accuracy calculation. In the example of FIG. 9, the UE performs actual measurements for 6 RSs 830 for accuracy calculation. In some embodiments, the UE may use not only the actual measurement results configured for accuracy calculation (e.g., the results of the measurements for the RSs 830), but the UE may also use the actual measurement results (e.g., the results of the measurements for the RSs 810) being used for the AI/ML-assisted measurement reduction. The UE may apply the received configuration of accuracy calculation and perform the accuracy calculation.

The network may configure accuracy calculation for multiple measurement reduction configurations even if some of the measurement reduction configurations are not being used by the UE. In other words, the network may configure accuracy calculation for multiple MRRT values.

If the accuracy calculation is for inter-frequency measurement reduction, a measurement gap may be configured. During the measurement gap, the UE does not expect the scheduling on the serving cell. The measurement gap may be periodically configured and aligned with the periodicity of measurement. When the UE performs the accuracy calculation, the UE may need to have a dense measurement gap. As the information is known to both the network and the UE, the UE may activate the measurement gap when the UE performs the accuracy calculation. The network may configure to the UE whether to apply the measurement gap during the accuracy calculation. A DCI, MAC CE, or RRC message may be used for configuration of the measurement gap activated during the accuracy calculation.

When a calculated accuracy of an AI/ML-assisted measurement reduction configuration is lower than a threshold, the UE may consider the functionality corresponding to the configuration as not applicable. The threshold may be configured by the network, for example, via a DCI, MAC CE, or RRC message. When a calculated accuracy of an AI/ML-assisted measurement reduction configuration is higher than a threshold, the UE may consider the functionality corresponding to the configuration as applicable. The threshold may be configured by the network, for example, via a DCI, MAC CE, or RRC message.

The accuracy calculation is performed by using measurement sample after L1 and/or L3 filtering. In order to obtain the L1 filtered measurement, the UE may start to perform the actual measurement in advance, and the L1 filtered measurement may be obtained by averaging multiple samples of actual measurements. The start time of accuracy calculation may be a certain time after the UE receives the message that the UE is asked to perform the accuracy calculation.

The UE may report the calculated accuracy for each measurement reduction configuration to the network. A UCI, MAC CE, or RRC message may be used for the report of the calculated accuracy. The calculated accuracy, in some embodiments, may be reported after the UE calculates the accuracy that UE is asked to calculate. In another embodiments, the calculated accuracy may be reported when an event occurs. An event may be that the calculated accuracy is lower than a threshold or higher than a threshold. The threshold may be configured by the network, for example, via an DCI, MAC CE, or RRC message.

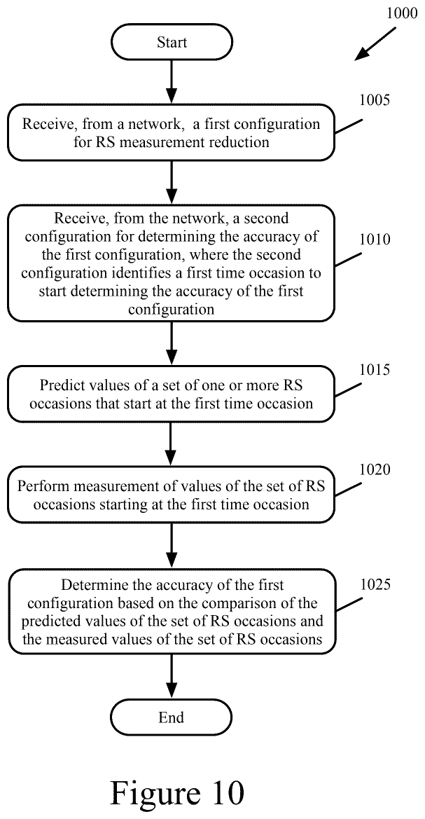

FIG. 10 is a flowchart illustrating an example method/process 1000 performed by a UE for determining the accuracy of RS measurement reduction configurations, according to an example implementation of the present disclosure. The process 1000 may be performed by at least one processor of a UE 101A-101C, shown in FIG. 1.

The process 1000 may receive (at block 1005), from a network a first configuration for RS measurement reduction. The RSs may be SSB, CSI-RSs, SRSs, or PT-RSs.

The process 1000 may receive (at block 1010), from the network, a second configuration for determining the accuracy of the first configuration. The second configuration may identify a first time occasion to start determining the accuracy of the first configuration. The second configuration, in some embodiments, may specify a periodicity for the first time occasion. For example, as described above with reference to FIG. 8, the time occasion to start determining the accuracy of the first configuration may have a periodicity 850. The process 1000, in these embodiments, may transmit the accuracy of the first configuration via RRC signaling to the network. The second configuration, in some embodiments, may specify the number of RS occasions in the set of RS occasions. In other embodiments, the number of RS occasions in the set of RS occasions may be determined by the UE.

The second configuration, in some embodiments, may identify the first time occasion as a one-time accuracy determination occasion. For example, as described above with reference to FIG. 9, the time occasion to start determining the accuracy of the first configuration may specify the start of a one-shot accuracy determination. The process 1000, in these embodiments, may transmit, to the network, the accuracy of the first configuration via either an RRC signaling, a UCI, or a MAC CE.

The process 1000 may predict (at block 1015) values of a set of one or more RS occasions that start at the first time occasion. The process 1000, in some embodiments, may predict the values of the set of RS occasions by using an AI/ML prediction model.

The process 1000 may perform (at block 1020) measurement of values of the set of RS occasions starting at the first time occasion. For example, the process 1000 may perform the measurement of the values of the RS occasions 830, as described above with reference to FIGS. 8 and 9. The process 1000 may perform the measurement of values of the set of RS occasions by performing measurement of values of a first group of RSs prior to the first time occasion, calculating the average of the measured value of each RS occasion and the measured values of a first group of prior RS occasions, and using the averaged values as the measured values of the set of RS occasions to determine the accuracy. The process 1000 may perform the measurement of values of the set of RS occasions by calculating the average of the measured value of each RS occasion and the measured value of a prior RS occasion, and using the averaged values as the measured values of the set of RS occasions to determine the accuracy.

The process 1000 may determine (at block 1025) the accuracy of the first configuration based on the comparison of the predicted values of the set of RS occasions and the measured values of the set of RS occasions. For example, the process 1000 may compare the actual measurement of the values of RS occasions 830 with the corresponding values determined by the AI/ML mode, and may decide the first configuration is accurate when the difference between the actual and predicted values are less than a threshold. For example, the process 1000 may receive, from the network, an accuracy threshold, and may stop using the first configuration when the accuracy of the first configuration is below the threshold. The process 1000 may then end.

In a case that the first configuration may be for measurement reduction of RSs received from a serving network cell that uses a first frequency band, the process 1000 may receive, from the network, a third configuration for measurement reduction of RSs received from a second network cell that uses a second frequency band different than the first frequency band. The process 1000 may receive, from the network, a fourth configuration for determining an accuracy of the third configuration, and may activate a measurement gap during which the UE performs accuracy determination based on the fourth configuration. The UE does not receive scheduling from the serving network cell during the measurement gap. The process 1000, in some embodiments, may receive the measurement gap, from the network, via RRC signaling.

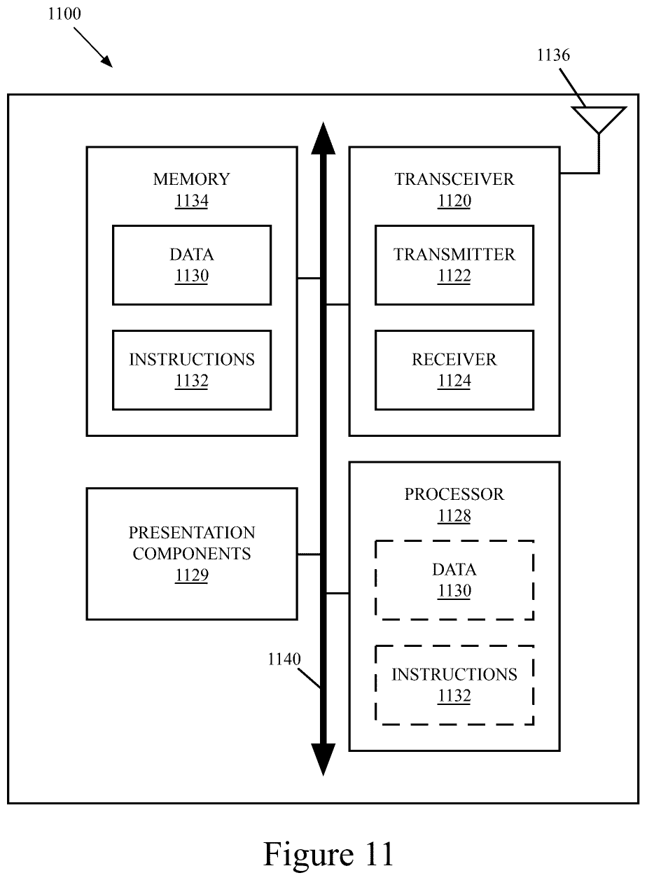

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1129, and at least one antenna 1136. The node 1100 may also include a radio frequency (RF) spectrum band module, a BS communications module, a network communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE, a BS, a LMF server, or any other network node on the RAN side or CN side that performs various functions disclosed with reference to FIGS. 1 through 10.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable, and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable instructions 1132 (e.g., software codes) that are configured to, when executed, cause the processor 1128 to perform various functions disclosed herein, for example, with reference to FIGS. 1 through 12. Alternatively, the instructions 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the instructions 1132 received from the memory 1134, and information transmitted and received via the transceiver 1120, the baseband communications module, and/or the network communications module. The processor 1128 may also process information to send to the transceiver 1120 for transmission via the antenna 1136 to the network communications module for transmission to a CN.

One or more presentation components 1129 may present data indications to a person or another device. Examples of presentation components 1129 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a network, a first configuration for reference signal (RS) measurement reduction;
receive, from the network, a second configuration for determining an accuracy of the first configuration, the second configuration identifying a first time occasion to start determining the accuracy of the first configuration;
predict values of a set of one or more RS occasions that start at the first time occasion;
perform measurement of values of the set of RS occasions starting at the first time occasion; and
determine the accuracy of the first configuration based on a comparison of the predicted values of the set of RS occasions and the measured values of the set of RS occasions.

2. The UE of claim 1, wherein the second configuration specifies a periodicity for the first time occasion.

3. The UE of claim 2, wherein the at least one processor is further configured to execute the one or more computer-executable instructions to cause the UE to:
transmit, to the network, the accuracy of the first configuration via radio resource control (RRC) signaling.

4. The UE of claim 2, wherein:
the second configuration further specifies a number of RS occasions in the set of RS occasions.

5. The UE of claim 2, wherein a number of RS occasions in the set of RS occasions is determined by the UE.

6. The UE of claim 1, wherein the second configuration identifies the first time occasion as a one-time accuracy determination occasion.

7. The UE of claim 6, wherein the at least one processor is further configured to execute the one or more computer-executable instructions to cause the UE to:
transmit, to the network, the accuracy of the first configuration via one of a radio resource control (RRC) signaling, an Uplink Control Information (UCI), or a Medium Access Control-Control Element (MAC CE).

8. The UE of claim 1, wherein:
performing the measurement of values of the set of RS occasions comprises:
performing measurement of values of a first plurality of RSs prior to the first time occasion,
calculating an average of the measured value of each RS occasion in the set of RS occasions and the measured values of the first plurality of prior RS occasions, and
using the averaged values as the measured values of the set of RS occasions to determine the accuracy.

9. The UE of claim 1, wherein:
performing the measurement of values of the set of RS occasions comprises:
calculating an average of the measured value of each RS occasion in the set of RS occasions and a measured value of a prior RS occasion, and
using the averaged values as the measured values of the set of RS occasions to determine the accuracy.

10. The UE of claim 1, wherein:
the first configuration is for measurement reduction of RSs received from a serving network cell that uses a first frequency band,
wherein the at least one processor is further configured to execute the one or more computer-executable instructions to cause the UE to:
receive, from the network, a third configuration for measurement reduction of RSs received from a second network cell that uses a second frequency band different than the first frequency band;
receive, from the network, a fourth configuration for determining an accuracy of the third configuration; and
activate a measurement gap during which the UE performs accuracy determination based on the fourth configuration, wherein the UE does not receive scheduling from the serving network cell during the measurement gap.

11. The UE of claim 10, wherein the at least one processor is further configured to execute the one or more computer-executable instructions to cause the UE to:
receive the measurement gap, from the network, via radio resource control (RRC) signaling.

12. The UE of claim 1, wherein the at least one processor is further configured to execute the one or more computer-executable instructions to cause the UE to:
receive, from the network, an accuracy threshold; and
stop using the first configuration when the accuracy of the first configuration is below the threshold.

13. The UE of claim 1, wherein the RS is one of a synchronization signal block (SSB), a channel state information reference signal (CSI-RS), a sounding reference signal (SRS), or a phase tracking reference signal (PT-RS).

14. The UE of claim 1, wherein:
predicting the values of the set of RS occasions comprises using an artificial intelligence/machine learning (AI/ML) prediction model.

15. A method, comprising:
receiving by a user equipment (UE), from a network, a first configuration for reference signal (RS) measurement reduction;
receiving, from the network, a second configuration for determining an accuracy of the first configuration, the second configuration identifying a first time occasion to start determining the accuracy of the first configuration;
predicting values of a set of one or more RS occasions that start at the first time occasion;
performing measurement of values of the set of RS occasions starting at the first time occasion; and
determining the accuracy of the first configuration based on a comparison of the predicted values of the set of RS occasions and the measured values of the set of RS occasions.
